(19) United States
(12) Patent Application Publication
(10) Pub. No.: US 2005/0019538 A1
(43) Pub. Date: Jan. 27, 2005

(54) Document sheet with recessed cavity having an access tab for an object received therein

(76) Inventor: Paul R. Edwards, St. Louis, MO (US)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 10/845,033

(22) Filed: May 13, 2004

Related U.S. Application Data
(60) Provisional application No. 60/470,279, filed on May 14, 2003.

(51) Int. Cl. B65H 29/24; B32B 1/00

(52) U.S. Cl. 428/221

(57) ABSTRACT

A document sheet generally comprised of a sheet of material, preferably paper stock, having an indentation area recessed in its front surface. In one portion of the indentation area, an object is secured. The other portion of the indentation area is configured and adapted to allow for the insertion of a tool for easier removal of the object from the sheet.

### CROSS REFERENCE TO RELATED APPLICATION(S)

This application claims priority to U.S. Provisional Application Ser. No. 60/470,279, filed May 14, 2003, the entire disclosure of which is herein incorporated by reference.

### BACKGROUND OF THE INVENTION

(1) Field of the Invention

The present invention pertains to a document sheet or a business form where an indentation(s) is formed in the front surface of the sheet and an object is adhered therein. In particular, to a sheet having an indentation which also includes a shaped access tab allowing a user of the sheet to access an edge of the adhered object for easier removal of the object.

(2) Background of the Invention

It is well known to provide document sheets and business forms with removable labels and cards adhered to the sheets and forms. The various different types of sheets and forms with adhered cards range from business forms with removable, adhesive-free data cards secured to the front surface of the forms such as that disclosed in the U.S. Pat. No. 4,890,862, to business forms with removable, self-stick labels fabricated within the thickness of the forms as disclosed in U.S. Pat. No. 4,379,573.

Document sheets and business forms of the type having data cards adhered to their front surfaces have been found to be disadvantaged in that the projecting height or thickness of the data card from the front surface of the sheet will at times cause the sheet to jam in a printing apparatus. Business forms and document sheets of the type where a self-adhesive label is fabricated within the thickness of the sheet often require the addition of an underlayment beneath the self-stick label. The cost of the underlayment and its attachment to the underside of the label and sheet contribute significantly to the overall cost of the document sheet.

### SUMMARY OF THE INVENTION

There is provided a document sheet with an attached object thereon having simplified, inexpensive construction and having a reduced cross sectional thickness enabling use of the sheet in printers without the risk of jamming the printer, while still allowing a human user to remove the object relatively easily.

In an embodiment, the document sheet is comprised of a sheet of material, preferably paper stock, having an indentation area recessed in its front surface and an object secured in a portion of the indentation area. The other portion of the indentation area is then configured and adapted to allow for the insertion of a tool (such as, but not limited to, a human finger) for removal of the object from the sheet. In variant embodiments, the document sheet is provided as a single sheet, and as a sheet of a continuous web of sheets wherein each individual sheet is separated by a transverse frangible line such as a perforation line. The individual sheets of the continuous web of sheets may also be provided with left and right side margins separated from the document sheets by frangible lines such as perforation lines and having pluralities of tractor holes provided therein as a conventional continuous web of computer printer paper.

The indentation(s) in the front surface of the sheet may be formed by compressing the material of the sheet from the front surface toward the back surface decreasing the thickness of the sheet in the indentation. Alternatively or additionally, both the front surface and back surface may be transposed backwards to form the indentation without decreasing the thickness. The configuration of the indentation area may vary to complement the configuration of an object to be adhered to the sheet in the indentation and the size and shape of the desired access tab. The depth of the penetration of the indention area into the document sheet and the thickness of the object to be adhered to the sheet in the indentation area may vary depending on the thickness of the stock material employed in constructing the sheet and the object attached.

An object is adhered within the indentation area on the indentation surface of the sheet. Preferably, the object is releasably adhered in the indentation area to permit its easy removal from the sheet. With the object being adhered to the indentation surface, a portion of the object's thickness is generally recessed into the indentation depth so that only a fraction of the object's thickness projects above the front surface of the sheet. This reduces the projection of the object from the front surface of the sheet and lessens the risk of the sheet and object jamming a conventional printer than heretofore has been available with prior art document sheets having cards affixed to their front surfaces.

Further, the indentation area is made purposefully larger or of different shape than the recessed object through the inclusion of an access tab. The access tab generally allows the edge of the object to be grasped by a finger or other tool to separate the object from the main portion of the indentation. This access tab may be of any shape but is preferably designed to accommodate a finger or fingernail and preferably allows access to a corner or edge of the recessed object so that the recessed object edge may be lifted from the indentation area. It is also generally preferred that the access tab be positioned such that when the sheet is printed, the object does not snag or catch in the printer due to the access tab.

There is disclosed herein, in an embodiment, a document sheet, which may be one of a continuous web of document sheets, comprising: a sheet of material, such as, nut not limited to, paper, having a front surface and a back surface and having a peripheral edge and a first thickness between the front and back surfaces; a main indentation formed in the sheet front surface, the indentation having an indentation surface recessed a first distance into the sheet thickness from the front surface; an access tab formed in the sheet front surface, the access tab having an access surface recessed a first distance into the sheet thickness from the front surface, the access tab intersecting the main indentation such that the combination of main indentation surface and access surface are completely surrounded by a portion of the sheet front surface not recessed; and an object having a first surface and a second surface, the object being received within the main indentation, and not within the access tab, and the second surface of the object being removeably secured to the indentation surface; wherein an access tool can be placed in the access tab to separate the object from the main indentation.

In another embodiment of the document sheet, the object second surface may secured to the main indentation surface by an adhesive that enables the object to be separated from the main indentation surface and the document sheet, or the access tool may comprise a human finger or fingernail.

In another embodiment of the document sheet some portion of the indentation surface is accessible around the periphery of the object when the second surface of the object is removeably secured to the indentation surface. The accessible portion of the indention surface may be insufficiently wide to allow the access tool to access the second surface of the object.

In another embodiment of the document sheet, the access tab may be generally circular or triangular in shape and may intersect a corner or edge; such as the bottom, side, or top; of the main indentation

In another embodiment of the document sheet, both the main indentation and the object have similar configurations which may be generally rectangular and may be identification cards.

In another embodiment of the document sheet, the main indentation is formed by compressing the front surface toward the back surface decreasing the first thickness in the main indentation or by transposing the front surface and the back surface backwards. The access tab may additionally or alternatively be formed by compressing the front surface toward the back surface decreasing the first thickness in the access tab or by transposing the front surface and the back surface backwards.

In another embodiment of the document sheet, the object has a second thickness between the first surface and the second surface that is at least equal to the first distance.

In a still further embodiment, there is disclosed herein a method of constructing a document sheet comprising: providing a sheet of material having a front surface and a back surface and having a peripheral edge and a first thickness between the front and back surfaces; forming a main indentation in the sheet front surface, the indentation having an indentation surface recessed a first distance into the sheet thickness from the front surface; forming an access tab in the sheet front surface, the access tab having an access surface recessed a first distance into the sheet thickness from the front surface, the access tab intersecting the main indentation such that the combination of main indentation surface and access surface are completely surrounded by a portion of the sheet front surface not recessed; and securing an object within the main indentation and not within the access tab in a manner so that an access tool can be placed in the access tab to separate the object from the main indentation.

### BRIEF DESCRIPTION OF THE DRAWINGS

FIG. 1 is a view of the front surface of a first embodiment of a document sheet and affixed object.

FIG. 2 is a view of the front surface of the embodiment of FIG. 1 with the affixed object removed for clarity.

FIG. 3 is a view of the front surface of another embodiment of a document sheet with the affixed object removed for clarity.

FIG. 4 is a view of the front surface of another embodiment of a document sheet with the affixed object removed for clarity.

FIG. 5 is a cross-sectional view of the embodiment of FIG. 1.

### DETAILED DESCRIPTION OF THE PREFERRED EMBODIMENTS

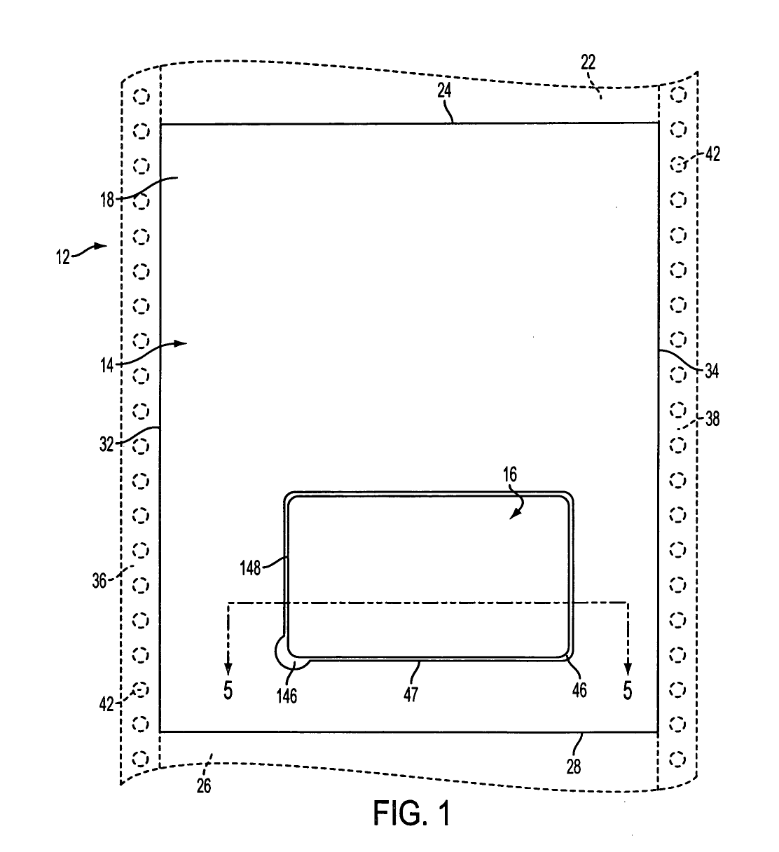

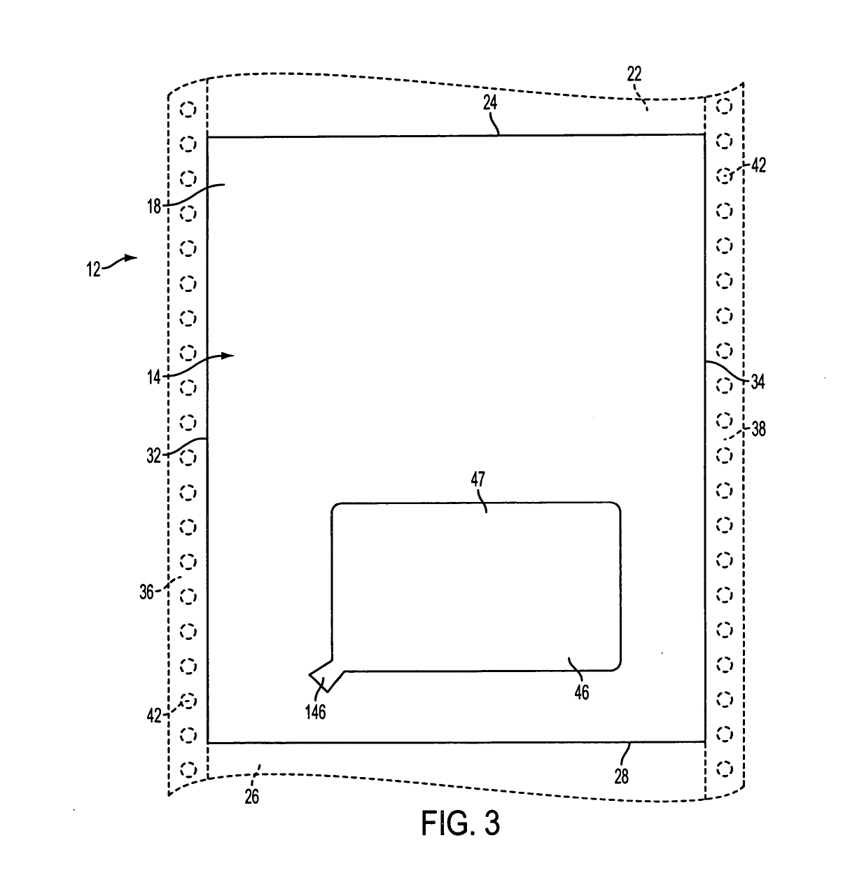

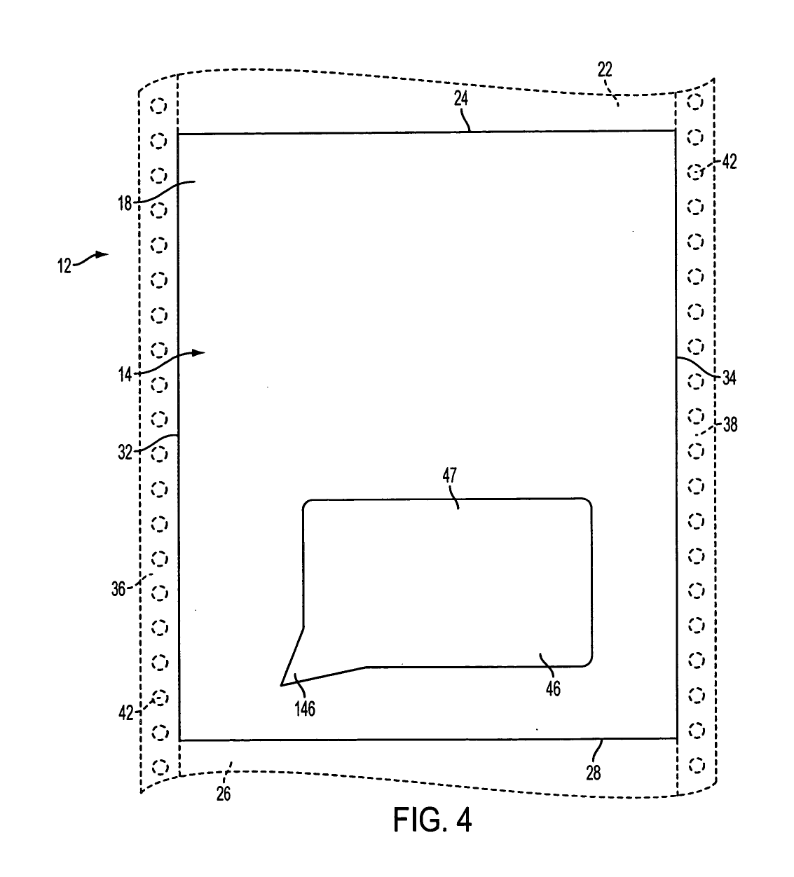

FIGS. 1 through 5 show various depictions of different embodiments of a document sheet (12) of the present invention constructed in accordance with the method of the present invention. The document sheet (12) is basically comprised of a sheet of material (14) and an object (16) adhered to the front surface (18) of the sheet (12). The sheet of material (14) is shown in solid lines in FIG. 1 as a single sheet (12). However, in variant embodiments of the invention, the sheet of material (14) may be one of a continuous web of sheets with a second (22) and additional like sheets connected along a top peripheral edge (24) of the sheet (12) and a third (26) and additional like sheets connected along a bottom peripheral edge (28) of the sheet (12). Alternatively or additionally, additional pages may be connected along the left (32) and right (34) peripheral edges of the sheet (12).

An Embodiment of the sheet (12) in which it is one sheet of a continuous web is represented in dashed lines in FIGS. 1-4. The top peripheral edge (24) connecting the sheet (12) to the second sheet (22) may be a frangible edge such as a fold line or a line of perforations that facilitate the separation of the two sheets along the line. Likewise, the bottom peripheral edge (28) of the sheet (12) may provide a frangible connection between the sheet (12) and the third sheet (26) with the frangible connection being provided by a fold line or a line of perforations. In a still further variant embodiment of the invention, the left (32) and right (34) peripheral edges of the document sheets may be frangible connections to left (36) and right (38) margins with tractor holes (42) provided therethrough as in tractor feed computer printer paper.

The material of the sheet (12) is generally continuous within the sheet's (12) peripheral edge, meaning that there are no holes or areas of different materials within the sheet's (12) peripheral edge. In an alternative embodiment, however, the sheet (12) may include various holes, cuts, or windows within its peripheral edge. These may include, but are not limited to, holes such as those used to make the paper fit in a binding, perforated tear lines, or slots. Although not shown, in variant embodiments the sheet (12) may also be provided with fold lines or tear lines within the peripheral edges (24), (28), (32), (34) of the sheet (12). The material of the sheet (12) is preferably paper stock and the thickness of the sheet (12) between the front surface (18) and back surface (44) of the sheet (12) may vary depending on the particular application desired for the document sheet.

An indentation area (47) is provided in the front surface (18) of the sheet (12). As shown in FIGS. 1 through 4, the indentation area (47) comprises two portions a main indentation (46) and an access tab (146). The main indentation (46) has a generally rectangular configuration conforming to the rectangular configuration of the object (16). However, the configuration of the main indentation (46) may take on a variety of shapes complementary to the configuration of a particular object (16) to be secured to the front surface (18) of the sheet (12). For example, if the object (16) was round, the main indentation (46) would also be generally round. The thickness of the object (16) is also preferably at least as large as the distance that the indentation area (47) is recessed into the sheet (12) from the sheet top surface (18). This can make it easier to print both the front surface of the document sheet and the front surface of the object simultaneously. Alternatively, an object having a lesser or equal thickness to the distance of recession of the indentation area (47) may be employed.

The indentation area (47) also includes an access tab (146) which is an area of indentation in contact with main indentation (46) but generally of significantly smaller size. The access tab (146) indentation is preferably intended to facilitate the removal of the object (16) from within the main indentation (46). In particular, as discussed below, the object (16) may be attached to the sheet (12) through the use of a removable adhesive. This may be to facilitate the printing of objects (16) which are printed, and then removed from the sheet (12) so that they are of a specific size. This can be, but is not limited to, identification cards or wallet cards. In such a case, an individual user will at some time wish to remove the object (16) from the sheet (12).

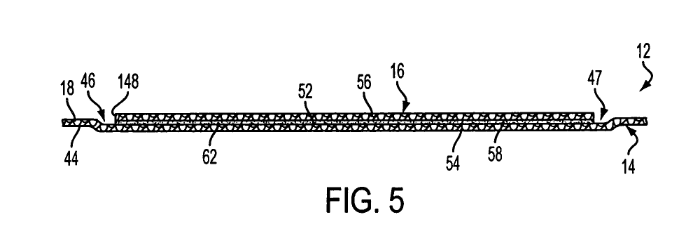

In an embodiment, an adhesive (62) may be used to adhere the object (16) to the sheet (12) which may extend at or near the outer edge (148) of the object (16) (see FIG. 5). In this case, to remove the object (16), a user will generally place a tool under the outer edge of the object (148) to separate the edge from the sheet (12) and then grasp the edge of the object and the sheet (12) and pull them apart (much like removing the backing from a sticker). In performing this action, however, the user needs to be able to place the tool under the edge (148) to commence the separation. In many cases, the tool may be fairly large, for instance it may be a fingernail, a finger, a letter opener, a mechanical remover, or any similar device designed to lift the edge of the object and separate it from the adhesive (62) and/or the sheet (12). Trying to get this tool within the space between the outside of the main indentation (46) and the edge (148) may be difficult as the tool may be wider than the space and increasing the space may result in the object (16) being caught by mechanisms within the printer resulting in a jam.

The access tab (146) provides for access by the tool to the edge (148) of the object (16). In a preferred embodiment, the access tab (146) is placed so as to allow access to a corner of the object (16), but in alternative embodiment access to any portion of the edge (148) may be granted. In an embodiment, the access tab (146) is preferably positioned so that the edge (148) adjacent the access tab (146) is generally not easily caught by a portion of the printer when the sheet (12) is being printed. For this reason, it is generally preferable to locate the access point (146) relative to the main indentation (46) either towards peripheral edges (32) or (34) or toward the bottom peripheral edge (28) of the sheet (12). In this way, components of the printer are either to the side of, or already over, the object (16), before they reach the access tab (146) as the sheet (12) is generally intended to be fed into the printer top peripheral edge (24) first and bottom peripheral edge (28) last.

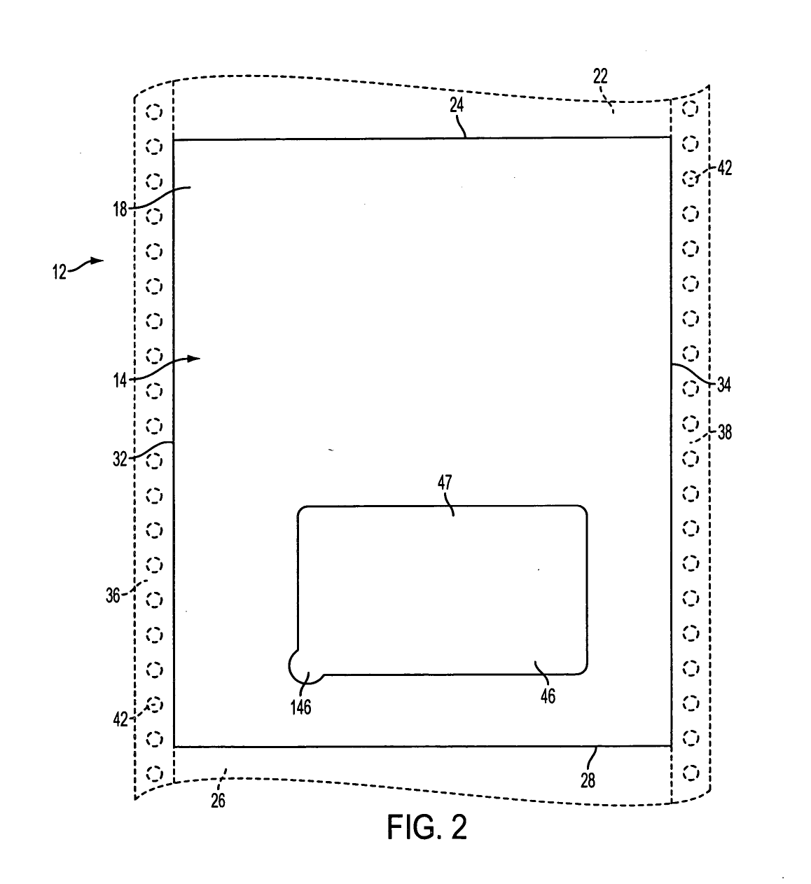

FIGS. 2 through 4 show three different embodiments of different shapes of access tabs (146) for a single shape of object (16) which has been removed in these FIGS. for clarity. Any of these shapes, or any other shapes, could be designed to accept a tool to remove the object (16) within the main indentation (46). Further, while all the different access tabs (146) are shown connected to the same corner, one of ordinary skill in the art would understand that the access tab (146) could be placed anywhere in contact with the main indentation (46) so as to form a singular indentation area (47) expressly including, but not limited to, attaching the access tab to any corner or side. Further, one or more than one access tab (146) could be used in conjunction with each main indentation (46). Further, each access tab (146) could be used with any other main indentation (46) of any shape.

Turning now to FIG. 5, it is discussed how the object is placed in the main indentation (46) in an embodiment. At the back (referring to the direction toward the bottom of FIG. 5 or into the page of FIG. 1) of the indentation area (47) is an indentation surface (52) of the sheet recessed from the sheet front surface (18) and into the thickness of the sheet (12) by a desired distance, the distance being dependent on the thickness of the sheet material and the thickness of the object (16) to be adhered to the sheet front surface (18) and also the method used to construct the indentation area (47). Generally, the indentation area (47) is formed into the thickness of the sheet (12) by pressing the material of the sheet (12), for example by using a conventional rotary press or letter press.

As should be apparent from FIG. 5, forming the indentation area (47) may be completed by compressing the front surface (18) toward the back surface (44) decreasing the thickness of the sheet (12) in the indentation area (47). Alternatively or additionally, the front surface (12) and back surface (44) of the sheet (12) may be transposed backwards in the indentation area (47) moving the portion of the sheet (12) in the indentation area (47) backwards relative to the rest of the sheet (12). Either of these two process, alone or in combination, would serve to form an indentation area (47) in the sheet (12) whereby the indentation surface (52) is recessed from the front surface (18) by a distance. One of ordinary skill in the art would further recognize that while this description refers to the indentation area (47) being recessed backwards relative to the front surface (18) of the sheet (12), the sheet (12) could alternatively be formed by recessing the sheet which is not in the indentation area (47) forwards. For simplicity, all of these forming methods, and others which would be understood by one of ordinary skill in the art, will be referred to as forming or recessing an indentation in the front surface (18) of the sheet.

It can also be seen in FIG. 5 that by forming the indentation area (47) into the thickness of the sheet (12), a projecting surface (54) may be formed in the sheet back surface (44) projecting about the same distance from the back surface that the indentation surface (52) extends into the sheet thickness from the front surface (18) if the front surface (18) and back surface (44) are simply transposed. The exact distance of projection generally will depend on the amount of compression, if any, of the sheet (12) forming the indentation surface (52) and the distance of indentation of the indentation area (47).

In the illustrative example shown in the various FIGS., the object (16) to be adhered to the sheet front surface (18) is a rectangular paper or cardstock identification card. However, various different types of objects may be employed with the document sheet of the invention. For example, self-adhesive labels, coins, tokens, keys, and a variety of different types of objects may be adhered to the front surface of the sheet in the main indentation (46), the only requirement being that the object(s) (16) have a limited thickness.

From FIG. 5, which shows a cross-sectional cut-through of the embodiment of FIG. 1 at line 5-5, the object (16) has a front surface (56) and a back surface (58), with the back surface (58) being adhered to the indentation surface (52). An adhesive (62) is employed to secure the object back surface (58) to the indentation surface (52). The adhesive (62) may be applied to the object bottom surface (58) or the indentation surface (52) prior to the object being received in the indentation and pressed against the indentation surface (52). The adhesive (62) may be a permanent adhesive, or preferably may be a releasable adhesive, enabling the object (16) to be easily removed from the indentation surface (52) and the sheet (12) when so desired. The adhesive (62) may be provided as a continuous layer or may be a non-continuous layer depending on the material used as adhesive (62) and the mechanisms or methods used to place it. The layer may be supplied as a pattern of dots, strips, or any other shape in an embodiment of the invention which may either maintain their individual shapes or may merge with each other to form a relatively continuous plane of material.

It can be seen in FIG. 5 that by forming the indentation (46) into the front surface (18) of the sheet (12), the thickness or the projecting height that the object (16) would project above the sheet (12) front surface (18) is lessened by the distance that the indentation surface (52) is recessed into the thickness of the sheet (12). The distance that the object (16) thickness would project above the front surface (18) of the sheet (12) if it were not received in the main indentation (46) is the distance that the projection surface (54) of the sheet (14) projects from the sheet back surface (44), less the change in sheet (12) thickness due to compression of the sheet (12) material when the indentation area (47) is formed. In this manner, the document sheet (12) of the present invention distributes the thickness of the object (16) adhered to the sheet (12) between the front surface (18) and back surface (44) of the sheet (12) so that the object (16) may be adhered to the sheet (12) while presenting a very small proturbance from the sheet (12) front surface (18) and back surface (44). Distributing the thickness of the object (16) on the front and back surfaces (18) and (44) of the sheet (12) enables the sheet (12) to provide an inexpensive document having an attached object, the both of which can be printed simultaneously by a conventional printer without as much risk of jamming the printer.

Although the document sheet (12) and method of the use are described above with reference to only a single object (16) adhered in the main indentation area (46) of the sheet (12), it should be understood that a plurality of objects (16) may be secured in one or more than one main indentations (46) in a variety of positions of both main indentations (46) and objects (16) on the sheet (12) and relative to each other.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A document sheet comprising:
a sheet of material having a front surface and a back surface and having a peripheral edge and a first thickness between the front and back surfaces;
a main indentation formed in the sheet front surface, the indentation having an indentation surface recessed a first distance into the sheet thickness from the front surface;
an access tab formed in the sheet front surface, the access tab having an access surface recessed a first distance into the sheet thickness from the front surface, said access tab intersecting said main indentation such that the combination of main indentation surface and access surface are completely surrounded by a portion of the sheet front surface not recessed; and
an object having a first surface and a second surface, the object being received within the main indentation, and not within said access tab, and the second surface of the object being removeably secured to the indentation surface;
wherein an access tool can be placed in said access tab to separate said object from said main indentation.

2. The document sheet of claim 1 wherein the object second surface is secured to the main indentation surface by an adhesive that enables the object to be separated from the main indentation surface and the document sheet.

3. The document sheet of claim 1 wherein said access tool comprises a human finger.

4. The document sheet of claim 1 wherein said access tool comprises a human fingernail.

5. The document sheet of claim 1 wherein some portion of said indentation surface is accessible around the periphery of said object when said second surface of the object is removeably secured to said indentation surface

6. The document sheet of claim 5 wherein said accessible portion of said indention surface is insufficiently wide to allow said access tool to access said second surface of said object.

7. The document sheet of claim 1 wherein said access tab is generally circular in shape.

8. The document sheet of claim 1 wherein said access tab is generally triangular in shape.

9. The document sheet of claim 1 wherein said access tab intersects a corner of said main indentation.

10. The document sheet of claim 1 wherein said access tab intersects an edge of said main indentation.

11. The document sheet of claim 10 wherein said edge comprises at least one of the bottom edge and a side edge.

12. The document sheet of claim 1 wherein said document sheet comprises one of a continuous web of similar document sheets.

13. The document sheet of claim 1 wherein both said main indentation and said object have similar configurations.

14. The document sheet of claim 13 wherein said configurations are generally rectangular.

15. The document sheet of claim 1 wherein said material is paper.

16. The document sheet of claim 1 wherein said object is an identification card.

17. The document sheet of claim 1 wherein said main indentation is formed by compressing said front surface toward said back surface decreasing said first thickness in said main indentation.

18. The document sheet of claim 1 wherein said access tab is formed by compressing said front surface toward said back surface decreasing said first thickness in said access tab.

19. The document sheet of claim 1 wherein said main indentation is formed by transposing said front surface and said back surface backwards.

20. The document sheet of claim 1 wherein said access tab is formed by transposing said front surface and said back surface backwards.

21. The document sheet of claim 1 wherein said object has a second thickness between said first surface and said second surface that is at least equal to said first distance.

22. A method of constructing a document sheet comprising:
Providing a sheet of material having a front surface and a back surface and having a peripheral edge and a first thickness between the front and back surfaces;
forming a main indentation in the sheet front surface, the indentation having an indentation surface recessed a first distance into the sheet thickness from the front surface;
forming an access tab in the sheet front surface, the access tab having an access surface recessed a first distance into the sheet thickness from the front surface, said access tab intersecting said main indentation such that the combination of main indentation surface and access surface are completely surrounded by a portion of the sheet front surface not recessed; and
securing an object within the main indentation and not within said access tab in a manner so that an access tool can be placed in said access tab to separate said object from said main indentation.
